(19) United States
(12) Patent Application Publication
(10) Pub. No.: US 2004/0037428 A1
(43) Pub. Date: Feb. 26, 2004

(54) Acoustically auditing supervisory audiometer

(76) Inventor: James E. Keller, Murphy, NC (US)

Correspondence Address: LUEDEKA, NEELY & GRAHAM, P.C., P O BOX 1871, KNOXVILLE, TN, 37901, US

(21) Appl. No.: 10/225,919

(22) Filed: Aug. 22, 2002

(51) Int. Cl. H04R 29/00

(52) U.S. Cl. 381/60

(57) ABSTRACT

A system is described which makes it possible for an audiometer to measure, analyze, and respond to acoustic signals that are present near the opening to the ear canal during audiometric testing. The signals monitored are those produced by the audiometer itself and any ambient noise present in the test environment. The system is implemented by permanently mounting a measurement microphone in each earphone enclosure so that the microphone can monitor the acoustic signals being produced by the earphone. The acoustic signals and ambient noise levels are then sampled and the sampled acoustic data is analyzed to provide verification of test signal integrity and to stop testing when the ambient noise level exceeds an acceptable level.

### FIELD OF THE INVENTION

In general, the present invention relates to the field of air-conduction (A-C) audiometric testing. More particularly, the invention relates to an improved acoustically auditing supervisory audiometer.

### BACKGROUND OF THE INVENTION

The present invention relates to the field of air-conduction (A-C) audiometric testing. A-C audiometry involves determination of the status of the human auditory system through the presentation of, and behavioral responses to, acoustic signals. Various signal types are routinely employed (e.g., pure tones, frequency modulated tones, and speech), and the electrical signal produced by the audiometer is typically converted to an acoustic signal by a transducer mounted in some type of enclosure, cushion or cuff that can be coupled to the auditory system, or by a speaker in a sound field. The generic term ‘speaker’ will be used to refer to the transducer that produces the acoustic test signal. The speaker may be a) a circum-aural earphone, b) a supra-aural earphone, c) an insert earphone, or d) a free-field speaker. The term ‘test sound field’ will be used to refer to the acoustic test signal produced by the speaker and referenced to the concha, or hollow bowl like portion of the outer ear, for earphone or sound-field testing, or to the tip of the cuff for insert speaker testing. For audiometric testing, the test sound field must be well defined and uncontaminated by extraneous sounds (those not produced by the audiometer). These requirements can be met by calibrating the audiometer and by testing in a sufficiently quiet environment.

In order to insure that audiometric test results obtained with different audiometers, and at different test sites, will be equivalent, audiometers are calibrated to a common standard; e.g., American National Standards Institute (ANSI) S3.6-1996 Specification for Audiometers. This standard specifies the target frequencies, levels, allowable harmonic content, and temporal characteristics for audiometric test signals as well as allowed deviations from target values. Audiometric calibration is typically done by coupling an industry standard transducer to an industry standard coupler and insuring that acoustic signals produced by the audiometer/earphone combination fall within the ranges specified by ANSI S3.6-1996. It is then assumed that the audiometer will ‘stay in calibration’; i.e., that the output as measured during calibration will not vary over time. In practice, however, it is recognized that an audiometer's acoustic output may change over time and that periodic re-calibration will be necessary.

Couplers recommended for calibration of audiometric earphones are specified in ANSI S3.7-1995 Method for Coupler Calibration of Earphones. These include the NBS-9A, IEC318, and HA-series coupler for calibration of super-aural, supra-aural, and hearing aid speakers, respectively. These couplers assume an “average” ear, one of average dimensions and with known, and stable, acoustic impedance as a function of frequency. Audiometric earphones and acoustic calibration couplers are designed to simulate the acoustic characteristics of the “average” human ear when coupled to an audiometric earphone. Acoustic characteristics of human auditory systems vary somewhat from person to person due to differences in head size and variance in shape and size of auditory physiological structures. Nevertheless, calibration data obtained on the standard coupler is assumed to be constant across the wide range of subjects to be tested. In addition, obtaining stable, repeatable earphone placement over a real ear can be difficult. Audiometer calibration can also be invalidated by circuitry malfunction, loose or oxidized connector contacts, or damaged cables. Currently available audiometers do not provide the ability to verify calibration accuracy while in use.

Extraneous acoustic signals, such as ambient noise in the test environment and noise produced by subject movement during testing must be acceptably low, or they may interfere with the acquisition of valid data (e.g., audiometric thresholds).

Allowable background noise for audiometric testing is specified in American National Standards Institute S3.1-1977 (R 1986) Criteria for Permissible Ambient Noise During Audiometric Testing and in CFR 29 Ch. XVII (Jul. 1, 2001 Edition), Section 1910.95, Appendix D. These documents indicate maximal noise spectra allowed in the sound-field test environment without significantly changing audiometric test results. The background noise is measured in the test area when the subject is not present and is then assumed to remain constant during sound-field testing, although this is not always the case. Neither document takes into consideration the attenuation provided by earphone seals or noise-attenuating earphone enclosures. Interference from unanticipated environmental noise is of greater concern when audiometric testing is done in less than ideal acoustic environments, such as school classrooms or industrial test environments, where it is not possible to completely control the presence of background ambient noise.

### BRIEF SUMMARY OF THE INVENTION

Some purposes of a preferred embodiment of this invention are to provide a system to automatically monitor an audiometer's acoustic signal output, to verify the integrity of the output in real time, to monitor the spectral characteristics of background noise in the test environment and to alert the operator, or to automatically interrupt the testing sequence if the noise could invalidate test results. Monitoring is preferably done at the ear, and is done before, during and after signal presentation. (“Or” is used in its broadest inclusive sense herein. It includes one, or some, or all of the options or choices.)

Another embodiment of the present invention is directed toward a method of performing an audiometric test with an audiometer that produces acoustic test signals. In accordance with the method, a measurement microphone positioned within the sound field produced by the audiometric transducer is used to monitor the acoustic test signals presented to the ear in real time. The measurement microphone allows the audiometer to automatically detect proper coupling of the audiometer to the subject's auditory system and initiate the audiometric test once the transducer is properly coupled to the subject's auditory system. The measurement microphone is also used to monitor ambient noise level and spectrum at the subject's ear. The test is stopped if the ambient noise exceeds a predetermined level. When the ambient level returns to an acceptable level, the test is resumed. In addition, calibration of the audiometer is automatically verified by using the subject's ear to couple the audiometer transducer to the subject's auditory system and measuring the interaural attenuation. Furthermore, the transfer of Reference Equivalent Threshold Sound Pressure Levels (RETSPLs) to new earphones via a probe-tube transfer method may be facilitated by using the measurement microphone as the probe tube microphone. The continuity of the connectors and cabling for the audiometer is verified by presenting known signals in the test field and acquiring and analyzing the signals output from the measurement microphone. The transfer of RETSPLs to a new coupler is also facilitated such that the measurement microphone readings can be directly compared to reference microphone readings in a standard coupler, and signal levels in the new coupler can be referenced to measurement microphone readings. Subject-generated noise due to body movements, coughing, cord noise, etc. is also measured at the subject's ear and any signal presentations interfered with by such noise are automatically repeated. The acoustic test signals of the audiometer are verified and adjusted based upon the monitored acoustic test signals of the audiometer.

An embodiment of the present invention is also directed toward an audiometer for performing an acoustic test. The audiometer includes a test field wherein the acoustic test is performed. The test field is preferably defined by a pair of earphones and the internal dimensions of the test subject's ear or is a free-field. A speaker introduces a test signal into the test field. A microphone detects sounds in the test field and produces an output. A signal analysis structure alters the test signals based upon the output of the microphone. An ambient noise monitoring system monitors the output of the microphone when the speaker is not producing a test signal and interrupts the test if the ambient noise exceeds a predetermined level. Monitors detect noise produced by a test subject and repeat the test procedure if the noise exceeds a predetermined level during a test interval. A memory stores a set of acceptable test parameters that are compared to the microphone output to determine if acceptable testing conditions exist. An output port downloads results of a test to a central computer for storage and processing.

The system provides improved efficiency in automated audiometric testing by making it possible to insure that the transducer array is properly ‘coupled’ to the auditory system by providing a means to detect and correct many circuit, connector and/or cabling problems, or by making it possible to insure that ambient noise levels are permissible. Daily calibration checks, such as those required by OSHA for Hearing Conservation programs, are facilitated by the invention, since these tests can be done without specialized coupler/measurement systems. Preferably the measurement microphone is included in the transducer assembly used for audiometric testing, and acoustic data from this microphone are acquired and analyzed in real time. Detection of situations that would lead to the acquisition of invalid data and providing a mechanism for their correction as they occur will reduce the need for retesting.

Miniature measurement microphones with good sensitivity, broad dynamic range, and long-term stability are preferred. Control and arbitration functions may be implemented in various forms (e.g., microprocessors or central processing units), but digital signal processors are ideally suited for digital audio control and analysis.

While a number of embodiments have been described above, the embodiments are exemplary, not limiting, and it should be readily understood that the invention is susceptible to a variety of modifications and configurations. Therefore, having summarized various aspects of the invention in simplified form, some embodiments will now be described in greater detail with reference to the following figures wherein similar reference numerals designate similar features throughout the figures.

### BRIEF DESCRIPTION OF THE SEVERAL VIEWS OF THE DRAWINGS

FIG. 1 is a block diagram of the acoustically auditing supervisory audiometer system;

FIG. 2a is an exploded view of an acoustic enclosure-style earphone with speaker and microphone installed on the mounting plate;

FIG. 2b shows a test setup with acoustic enclosure-style earphones, a cord-mounted audiometer, a wireless response button, and a personal computer;

FIG. 3a is an enlarged view of an ear-level microphone mount;

FIG. 3b shows a sound room test setup with a microphone mounted on an ear-level holder, sound field speakers, a wireless response button, and stand-alone audiometer outside the booth;

FIG. 4a is an enlarged view of an insert speaker assembly including the measurement microphone;

FIG. 4b shows a test system using insert earphones, a cord-mounted audiometer, a wireless response button, and a personal computer;

FIG. 5 is a flow chart for bioacoustic calibration check paradigm; and

FIG. 6 is a flow chart for acoustic signal monitoring paradigm.

### DETAILED DESCRIPTION OF THE INVENTION

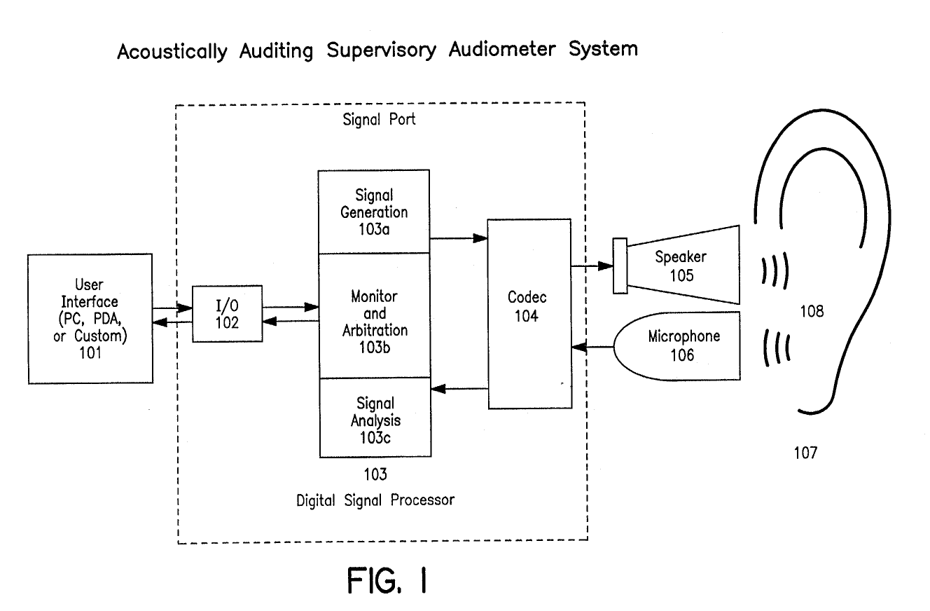

The acoustically auditing supervisory audiometer depicted in FIG. 1 is a hearing test system that automatically monitors its acoustic signal output to verify the integrity of the output in real time, monitors the spectral characteristics of ambient noise at the listener's ear in real time, and provides operator alerts and/or automatic test interruption if the noise could invalidate the test results. Monitoring of the test sound field is done before, during, and after signal presentation. For earphone testing, this test sound field is the volume of air enclosed between the earphone and the eardrum. For sound-field testing, it is the free field acoustic signal as measured at the concha. This system, in stylized form, is shown in FIG. 1. It consists of a user interface 101, a digital input/output bus 102, a digital signal processor 103, a codec 104, and a speaker 105 and microphone 106 in a ‘test sound field’ 108 coupled to the ear 107. The digital signal processor 103 includes a signal generation section 103a, monitor and arbitration logic 103b, and a signal analysis section 103c. Some applications may require a power amplifier to drive the speaker. The microphone 106 monitors the acoustic signal created by the speaker 105 in the test sound field 108. The control and arbitration logic 103b is capable of alerting the operator to detected failure modes via the user interface 101 or automatically suspending or ending a test when a failure mode is detected. (Again, “Or” is used in its broad inclusive sense, herein.) The I/O link 102 between the user interface 101 and the digital signal processor 103 may be a wired link, an infrared link, or a wireless radio link. The I/O link 102, digital signal processor 103 and codec 104 may be referred to collectively as the ‘Signal Port’.

The preferred Signal Port data generation and acquisition components include the ability to process data at a rate suitable for audio frequencies (i.e., 32 kHz or greater) and sufficient resolution to support the mathematical processing to be done (i.e., 16 bits or greater). The Signal Port processor also preferably a) has sufficient bandwidth to process samples received from the converter at the selected sampling rate, b) provides the mathematical processing capability needed to verify signal integrity and to quantify ambient noise characteristics, c) performs the necessary mathematical processing to convert amplified microphone signals into scalable units, d) performs sufficient mathematical analysis to insure compliance with ANSI S3.6 and ANSI S3.1 standards, and e) is capable of performing test control and data communication functions sufficient to control the overall test presentation paradigm, to interrupt the test when necessary, to indicate to the tester that the test has been interrupted, to indicate why the test has been interrupted, and at the operator's discretion (or automatically), to continue the test.

The acoustically auditing supervisory audiometer is a closed-loop feedback system. The signal analyzer 103c is used to measure relevant parameters of the signal from the microphone 106 and these parameters are fed to the arbitration logic 103b that decides what corrective action, if any, is indicated. For instance, if the sound pressure level being produced differs from the expected level (as measured by the microphone), the difference can be reported via the I/O link 102 to the user interface 101, noted in the audiometric data report, and taken into account when assessing thresholds. When the signal generator 103a is not producing a signal, the microphone 106 measures only ambient (background) noise. This signal can be used to verify that the background noise is low enough to allow testing.

Any relevant signal parameters may be investigated as needed by varying the nature of the analysis that is performed. For example, the harmonic content of a test signal may be verified by calculating the Fast Fourier Transform (FFT) of the microphone signal and calculating the percent of total harmonic distortion from the spectral data. The arbitration logic 103b in this case would check to insure that the distortion figure does not exceed that allowed by the ANSI S3.6-1996 calibration standard. Interaural attenuation, which is important when attempting to apply masking noise without over-masking, can be measured directly by presenting a test signal to one ear and measuring the level of the cross-over signal at the contralateral ear.

Implementing this closed-loop “generation, measurement, feedback, control” system results in an audiometric test instrument which can ‘acoustically audit’ its own signal generation, as well as any extraneous noise that exists in the test environment, and make decisions based on the audit results. Microphone measurements made within the test acoustic field formed by the auditory system and the speaker can be used to quantify individual differences among subjects and to verify that signal parameters are consistent with those expected.

While ANSI S3.6-1996 provides specifications for several “standard” transducers, it also allows for the addition of new transducers and specifies procedures for transfer of reference equivalent threshold sound pressure levels (RETSPLs) from standard to new transducers (ANSI S3.6-1996, p 30, section D.2). A similar technique would allow transfer of RETSPLs from standard to new couplers as well. Inclusion of a measurement microphone within the transducer housing will in turn make possible the use of the speaker's auditory system as a ‘coupler’. Measuring the sound pressure levels generated within the housing for a fixed HTL value and cross-referencing the values to a standard coupler/transducer system allows the required RETSPL corrections to be determined.

Since sampling of the test sound field may be done at any time, measurement of the ambient noise level within the test sound field may be done just before and just after signal presentation. The former verifies that the noise level is low enough to present a test signal, and the latter determines whether or not the noise level increased enough during signal presentation to invalidate the presentation. In the case of earphone testing (over the ear or insert), the ambient noise will be attenuated by the acoustic insulating characteristics of the speaker enclosure, however, the noise due to body and cable movement may actually be louder due to the occlusion effect. Nevertheless, in preferred embodiments of the present invention, the microphone reading will give, in either case, an accurate indication of the noise actually perceived by the subject. This allows the testing to be done in slightly higher ambient noise levels than would otherwise be permissible when ‘over the ear’ phones are used, and will allow detection of subject-generated noise. If the ambient or subject generated noise level becomes sufficiently high at any point to interfere with the acquisition of valid thresholds, the arbitration logic can suspend the test until the noise level decreases to an acceptable level. The test can be halted and the operator notified accordingly if the noise level does not decrease sufficiently within a specified amount of time.

Another factor that can interfere with the assumption of a properly calibrated signal presentation is the fact that the transducers are typically connected to the audiometer via cables with connectors. If these connectors do not make optimal contact for any reason, there will be unpredictable changes in signal level and/or undesirable signals introduced into the test situation. Regardless of the actual source of high-impedance paths or interruptions in the signal path, their presence can be detected by monitoring the end product, i.e., the acoustic signals being generated.

Although the preferred audiometer of the present inventions has two channels, only one is shown in the block diagram of FIG. 1 for clarity. The optimal method for implementing this invention takes advantage of the availability of high quality digital audio (e.g., 24-bit, 96 kHz A/D, D/A, and codec) and digital signal processor (DSP) technology currently available. Digital signal processors provide an ideal solution for controlling signal generation, signal acquisition, signal analysis, and control functions. Modern day DSP circuits include versions that are low in power, small in size, and capable of implementing all the processing algorithms described for this invention. Use of a programmable DSP also allows processing algorithms to be adapted as necessary for use with different transducers and for different test environments.

The preferred embodiment shown in FIG. 1 is based on a user interface 101 interfaced to a 16-bit integer DSP 103 via Universal Serial Bus (USB) input/output 102. The user interface 101 could be a personal computer (PC), a personal data assistant (PDA), or a custom keyboard/display system interfaced via a data link. The DSP signal generation module 103a and signal analysis module 103c are both implemented in code and controlled by the monitor/arbitration logic module 103b. The output of the signal generation module 103a is fed to the digital input of a 24-bit, 96 kHz audio codec (e.g., Texas Instruments TLV320AIC23) 104, and the analog output of the codec, optionally amplified, is used to drive the speaker 105. The signal from the microphone 106, optionally preamplified, is delivered to the analog audio input of the codec 104. The digital output of the codec is then routed back to the DSP 103 for processing by the signal analysis module 103c. The speaker 105 and measurement microphone 106 are coupled in the ‘test acoustic field’ 108 so that acoustic signals produced by the speaker and ambient noise may be monitored.

Once the microphone 106 has been installed in the transducer assembly, and the signal path established from the microphone to the optional preamplifier, codec 104, analog to digital converter, and signal analyzer 103c, the microphone frequency response and a table of correction factors is determined. The measurement sensitivity of the microphone 106 is then determined, so that the microphone readings can be converted to sound pressure levels. Once this is accomplished, the measurement system may be used to calibrate earphones in standard, or non-standard, couplers using the probe tone transfer technique described in ANSI S3.6-1996. Since this invention essentially places the ‘probe tube’ inside the earphone, RETSPL values can be easily transferred from a standard reference coupler to a coupler of a different type and a calibration cavity made a part of each audiometer system. Locating the measurement microphone in the earphone assembly makes it possible to measure the actual sound pressure level being presented to the actual test subject, rather than assuming that calibration coupler values are valid for the wide range of ear sizes encountered in individuals.

In addition, sufficient logic may be included to determine when a test should begin (e.g., the headset has been symmetrically placed on the head with transducers over the ears), when a test needs to be suspended (e.g., when ambient noise level exceeded allowable level), when a test needs to be halted (duration of unacceptable ambient noise exceeded a cutoff point), or when testing can not be done due to one of several possible electromechanical failure modes. Each of these objectives are achieved through the use of basic signal processing techniques.

As discussed above, another benefit of the acoustically auditing supervisory audiometer of FIG. 1 is that the measurement microphone can be used to determine when a test may begin. For example, an inaudible signal (e.g., 10 Hz) may be presented to the earphone and monitored by the measurement microphone. As long as the earphone is not seated over the ear, the level of the 10 Hz signal picked up by the microphone would be low, but would notably increase when the earphone is placed over the ear. Automatic testing may be initiated based upon the increased signal level without the need for an examiner to manually start the test for each subject. This would be particularly useful during group test situations, as each subject would begin their test when ready simply by putting on the earphones. The same technique can be used to insure that an earphone is properly coupled to the ear. A slight acoustic leak will result in lower than expected signal levels in the low frequencies, and this result indicates the need for an earphone adjustment.

The acoustic measurement technique of the preferred embodiments of the present invention can be used with many of the standard transducers currently used for audiometric testing, and can easily be adapted for use with transducers developed in the future. Commonly used audiometric transducers include Telephonics TDH-39 earphones, Sennheiser HDA 200 earphones mounted in acoustic enclosures, insert phones sealed in the ear canal using pliable cuffs, and various ‘free field’ speakers. The measurement microphone can be ideally accommodated in an earphone mounted in an acoustic enclosure. Such earphones typically include a mounting plate for the transducer, and the measurement microphone can be installed on this same mounting plate.

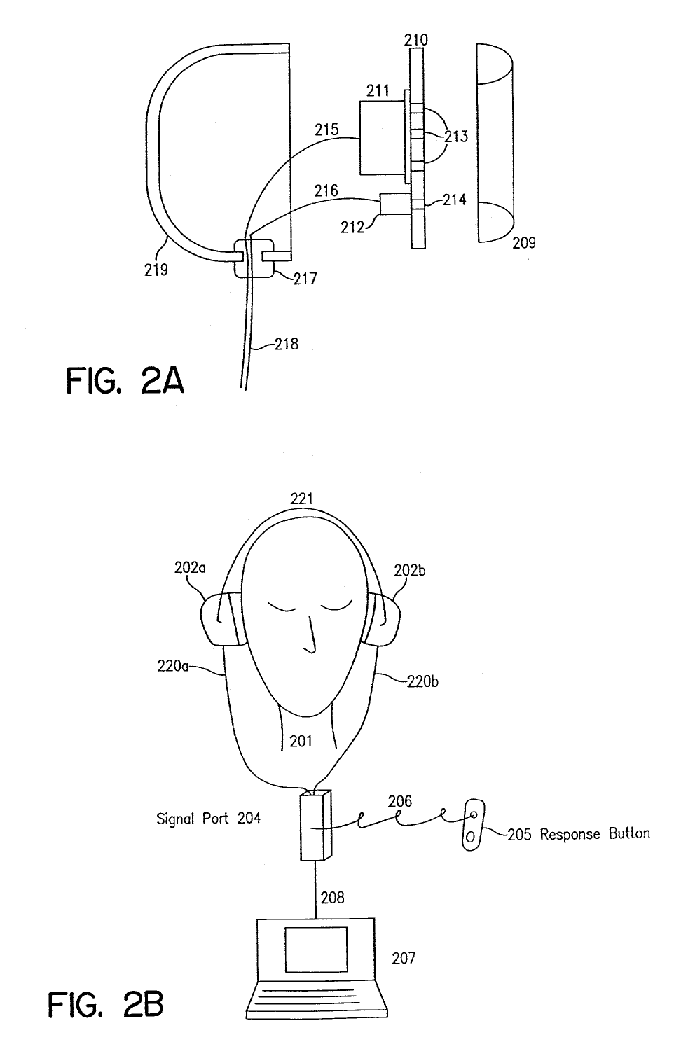

FIG. 2a shows an exploded view of such a preferred earphone. The speaker 211 and microphone 212 are attached to a mounting plate 210 that fits into the acoustic enclosure 219. The acoustic signal produced by the speaker exits the mounting plate through several holes 213. The port of the measurement microphone 212 is positioned over a hole 214 in the plate 210. Any one of several widely available miniature microphones may be appropriate for use as the measurement microphone (e.g., Panasonic WM-61A). A strain relief 217 mounted in a hole through the acoustic enclosure secures a cable 218 that conveys the microphone wiring 216 and speaker wiring 215. A padded ring 209 fits on the front of the earphone enclosure 219 to form an acoustic seal against the head of a user when the earphone is placed over the ear.

FIG. 2b shows an embodiment of the invention using acoustic-enclosure style earphones. A subject 201 is fitted with a pair of earphones 202a/202b mounted on a headband 221. A small inline module houses the Signal Port 204. The earphone/microphone cables 220a/220b are attached to the Signal Port 204, and the Signal Port 204 is attached via I/O link 208 to a personal computer 207 that serves as the user interface. The subject response button 205 may be attached to the audiometer via wiring, an infrared link, or a radio link 206. The measurement microphone in this embodiment monitors the acoustic signal produced by the speaker within the earphone enclosure and the ambient acoustic signal after it has been attenuated by the earphone enclosure. Thus, the embodiment of FIG. 2b allows for calibration and ambient noise compensation based upon the actual conditions present in the vicinity of the test subject's ear.

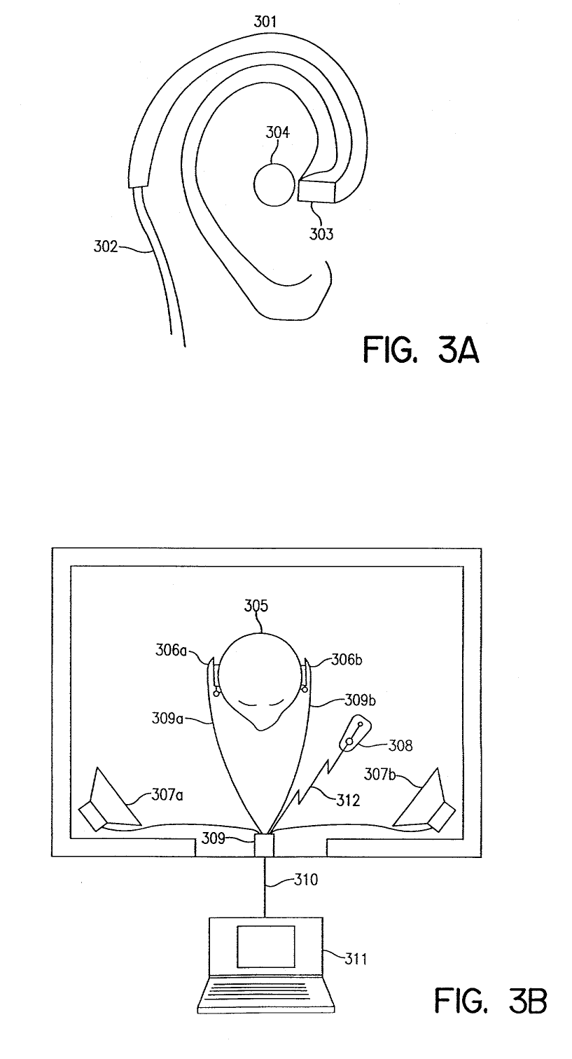

FIG. 3a shows a measurement microphone 303 attached to an ear-level holder 301 that fits over the external ear and positions the microphone port in the concha 304 without obstructing it. The microphone's wiring is routed through a cable 302 attached to the holder 301. This embodiment of the invention is suitable for free-field audiometric testing. FIG. 3b shows a subject 305 seated in a sound-treated booth wearing two ear-level microphone holders 306a/306b. The subject response button 308 is interfaced to the signal port 309 via wiring, an infrared link, or a radio link 312. The microphone cables 309a/309b are routed to a signal port 309 and the I/O link 310 passes through the booth wall to a personal computer 311. The test acoustic field in this case is the acoustic signal produced by sound field speakers 307a/307b as measured at the concha.

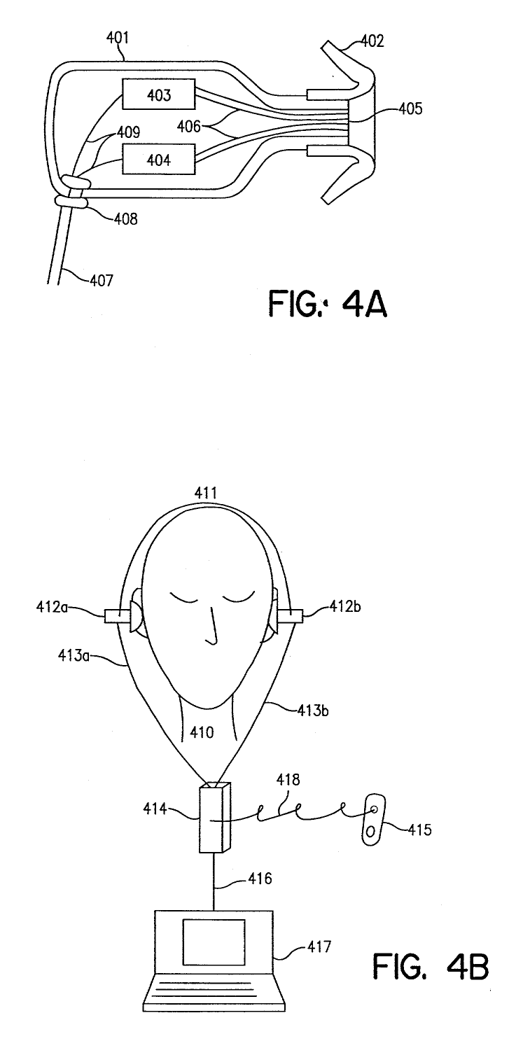

FIG. 4a shows another embodiment in which the measurement microphone is installed in an insert probe-style phone, which might be mounted on a headband, hand-held, or sealed in the ear canal. The measurement microphone 404 and speaker 403 are mounted inside the probe housing 401 and coupled to the probe tip 405 through tubes 406. A flexible cuff 402 seals the insert phone in the ear canal. A strain relief 408 mounted in a hole through the earphone enclosure 401 secures a cable 407 conveying microphone and speaker wiring 409. FIG. 4b shows a subject 410 fitted with a pair of insert earphones 412a/412b mounted on a headband 411. The headphone cables 413a/413b are attached to a small inline cabinet 414 containing the Signal Port, and the Signal Port 414 is attached via I/O link 416 to a personal computer 417, which serves as the user interface. The test acoustic field is the volume of air between the probe tip and the eardrum. The subject response button 415 may be attached to the audiometer via wiring, an infrared link, or a radio link 418. The measurement microphone 404 in this embodiment monitors the acoustic signal produced by the insert phone speaker 403 within the ear canal and the ambient noise signal after attenuation by the insert phone.

In another embodiment, an accelerometer could be coupled to an electro-mechanical oscillator to allow real-time monitoring of the signals used for bone conduction audiometric testing. The principles would be the same for this embodiment as those discussed above with force signals measured by the accelerometer replacing acoustic signals measured by the microphone as the feedback signal.

In yet other embodiments of the present invention, part of the signal generation and data acquisition system (signal port) could be mounted in the earphone enclosure or on the headband, placed on a tabletop or in a wall-mounted box. Separate D/A and A/D converters could be used for signal generation and data acquisition. Any appropriate processor or logic circuit could accomplish the data acquisition, scaling, and conversion to engineering units of interest and assure that the signals conform to the applicable standards.

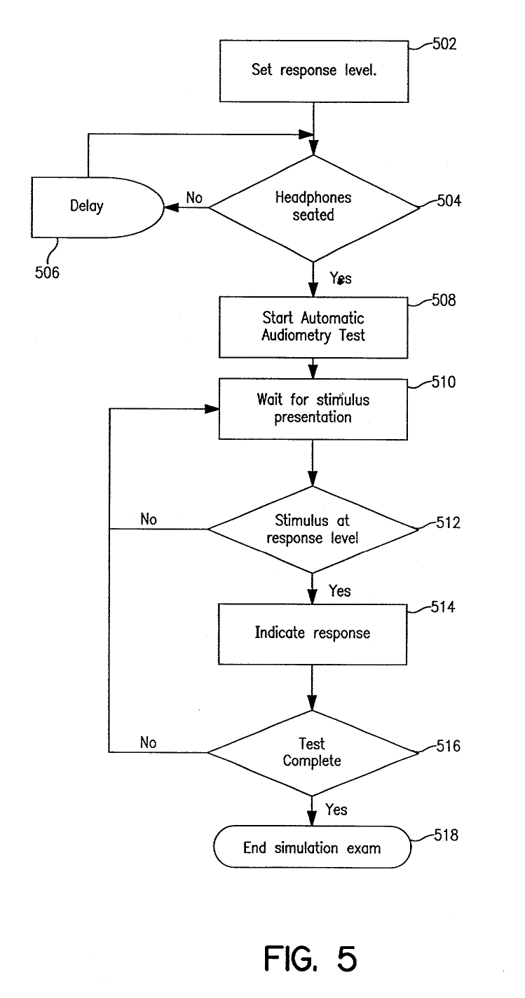

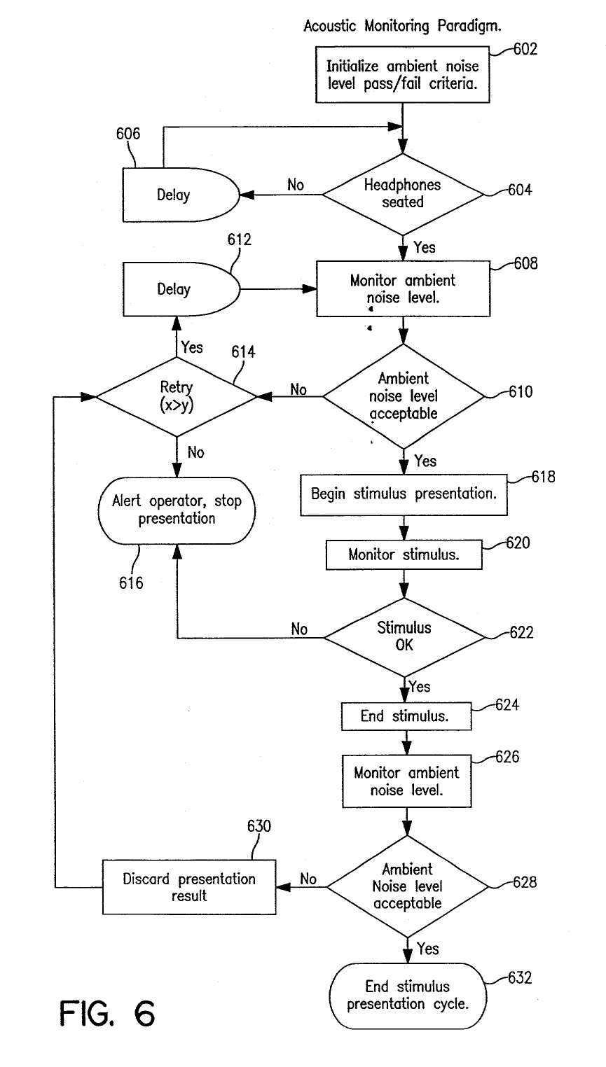

The effectiveness of the preferred embodiments of the present invention can be best understood by considering what occurs during a typical industrial hearing conservation test sequence. Prior to beginning a day's testing, the transducer (earphone) assembly is placed on either a standard coupler (e.g., B&K 4152) or a ‘simple’ 6 cc coupler designed as a holder for the headphones. A daily ‘bioacoustic simulation’ calibration check is done using the flow chart shown in FIG. 5. In accordance with FIG. 5, the desired ‘response level’ is set in block 502, proper seating of the headphones is verified in blocks 504 and 506 and an automatic audiometry test is begun in block 508. The amplified signal from the measurement microphone is then sampled when test signals are presented in block 510, and if it exceeds the preset response level in block 512, a ‘response’ is recorded in block 514, exactly as if a bioacoustic simulator had provided the response. This procedure is repeated for each test frequency as represented in block 516, and the results examined to insure that ‘responses’ are at the anticipated level. When all the signals pass calibration check, the simulation exam ends in block 518 and an automatic audiometry test can be administered (e.g., refer to FIG. 2b and the flow chart shown in FIG. 6).

Referring now to FIG. 6, a flow chart of a method for performing an acoustic test in accordance with an embodiment of the present invention is shown. During the test, the subject is seated, given a response button, and the headphones put on. Test instructions are given by the instructor or from a pre-recorded source via the earphones. The method begins with the initializing of the ambient noise level pass/fail criteria as shown in block 602. In blocks 604 and 606, earphone seating verification signals are presented, and the results are processed to verify that the earphones are placed symmetrically and that acoustic leakage is acceptably low. A reading of the ambient noise level is then taken in blocks 608 and 610 to determine if the ambient noise level is acceptable and the test may begin. Optionally, each of the test signals may be presented at a comfortable listening level to familiarize the subject with the test signals, and during these presentations, signal integrity and level are monitored, and error conditions flagged. If an error is detected which may resolve itself in time (e.g., high ambient noise level), the test is suspended temporarily as shown in block 612 to see if the situation will resolve itself. If a ‘catastrophic’ error is detected in block 614 (e.g., loss of signal generation), the test is halted and the operator is alerted as to the nature of the error in block 616.

Assuming that no error conditions are detected, the automatic test begins with the presentation of a stimulus as set forth in block 618. As discussed above, prior to the presentation of each signal, the ambient noise level at the ear is sampled, and if found to be within acceptable level/spectral parameters, the test continues. Otherwise, the test is temporarily halted, and the ambient noise monitored until it either falls within the acceptable range, or if too much time elapses, the test is permanently halted and the operator alerted to the error condition. In block 620, the stimulus presented to the subject is monitored. During actual testing, many audiometric signals will be low in amplitude, but can be monitored using a narrow-band digital filter centered at the test frequency. At extremely low audiometric test levels, the signal will not be measurable. In block 622, it is determined whether or not the presented stimulus is acceptable. The primary purpose of this signal monitoring during testing is to detect unexpected acoustic interference produced by the audiometer itself, such as a discontinuity at the earphone connector. A discontinuity would produce a noticeable change in signal level or an unexpected pop or click which could be detected using any of several measurement techniques (e.g., spectral analysis, sample/hold peak detection, etc.). When the signal presentation is over as shown in block 624, the ambient noise is sampled in blocks 626 and 628 to verify that it is still acceptable. If so the method proceeds to block 632 wherein the subject response obtained for the signal is considered valid. If not, the presentation result is rejected in block 630 and the signal presentation is repeated.

Mounting a measurement microphone within the acoustic field formed between the acoustic transducer and the tympanic membrane allows monitoring of the acoustic signal presented by an audiometric earphone while it is in use. Monitoring the acoustic signal present within this acoustic field provides several advantages regarding the verification of test signals and the ability to insure that ambient noise within the test environment does not interfere with the accuracy of audiometric testing. Additionally, the ability to directly monitor the acoustic output of the audiometer allows for improvements in efficiency of automatic test routines, and for simpler, less expensive, and completely automated methods for doing daily calibration checks.

Specifically, inclusion of a measurement microphone within the acoustic field allows signal levels to be monitored as signals are actually being presented in the test situation, rather than assuming that calibration values determined in a standard coupler are applicable to all test subjects. Signal level and spectral composition are directly determined, and any deviation from expected values is detected and the operator alerted to the presence of a problem. Possible error conditions include unusually low or high signal levels with respect to expected levels, the presence of unacceptably high harmonic distortion, ‘clicks’ or ‘pops’ indicative of an intermittent electrical connection, etc. The invention also makes it possible to monitor the ambient noise level, including noise produced by the subject, to insure that such noise remains below levels that would interfere with test results and to automatically repeat or stop the test if noise levels become too high. Monitoring of signals within the acoustic field also facilitates the streamlining of certain test procedures; e.g., the control processor detects placement of the earphones over the ears and begins test control and monitoring automatically. Operator intervention is only required when an unsolvable error is detected.

In short, equipping audiometric transducer assemblies with a measurement microphone and appropriate data acquisition and processing circuitry would make the audiometer “self-monitoring”; i.e., able to insure that its own signal generation and control functions are operating properly, and that the test environment adheres to required ambient noise restraints. Monitoring the acoustic output of the audiometer and ambient noise in real time will provide the ability for the audiometer to be “supervisory” during actual test situations, make it possible to adapt the test flow in response to conditions that might effect the accuracy of test data. Test efficiency could be improved and calibration checks could be done easily due to the nature of the monitoring system and of the ability to process the acoustic signal produced by the transducer and to make decisions based on its actual versus expected characteristics.

In view of the above explanation of the particular features of the present invention, it will be readily appreciated by one skilled in the art that the present invention can be usefully employed in a wide variety of embodiments. While certain embodiments have been disclosed and discussed above, the embodiments are intended to be exemplary only and not limiting of the present invention. The appropriate scope of the invention is defined by the claims set forth below.

1. A method of performing an audiometric test with an audiometer that produces acoustic test signals, said method comprising:
using a measurement microphone positioned in the test sound field of the audiometric transducer to monitor the acoustic test signals produced by the audiometric transducer during a test; and
adjusting characteristics of the acoustic test signals of the audiometer based upon the monitored acoustic test signals produced by the audiometer during the test.

2. The method of claim 1 further comprising monitoring the ambient noise present in the test sound field during testing with the measurement microphone coupled to the ear.

3. The method of claim 2 further comprising stopping the audiometric test if the ambient noise sensed by the test sound field measurement microphone exceeds a predetermined level.

4. The method of claim 2 wherein the step of monitoring the ambient noise with the measurement microphone further comprises monitoring the ambient noise spectrum at the subject's ear, and suspending the audiometric test if the monitored noise level is unacceptably high, resuming the audiometric test if the monitored noise level returns to an acceptable value, or discontinuing the test if a time out error condition occurs.

5. The method of claim 1 further comprising:
acquiring data from the test sound field measurement microphone in real time during the test;
processing the acquired data in real time during the test; and
verifying the integrity of the test signals in real time during the test based upon the acquired data.

6. The method of claim 1 further comprising measuring subject-generated noise at the subject's ear with the test sound field measurement microphone and automatically repeating any signal presentations interfered with by such noise.

7. The method of claim 1 further comprising automatically detecting proper coupling of the audiometric transducer to the subject's auditory system.

8. The method of claim 7 further comprising automatically initiating the audiometric test once the audiometric transducer is properly coupled to the subject's auditory system.

9. The method of claim 1 further comprising automatically verifying calibration of the audiometer by using the subject's ear as the calibration coupler.

10. The method of claim 1 further comprising automatically detecting error conditions during audiometric testing by monitoring the test sound field microphone's output.

11. The method of claim 1 further comprising verifying continuity of connectors and cabling for the audiometer by presenting known signals and acquiring and analyzing signals from the test sound field measurement microphone.

12. The method of claim 1 further comprising self-calibrating the audiometer.

13. The method of claim 1 further comprising facilitating the transfer of Reference Equivalent Threshold Sound Pressure Levels (RETSPLs) to new earphones via a probe-tube transfer method by using the measurement microphone as the probe tube microphone.

14. The method of claim 1 further comprising facilitating the transfer of RETSPLs to a new coupler such that the measurement microphone readings can be directly compared to reference microphone readings in a standard coupler, and signal levels in the new coupler can be referenced to measurement microphone readings.

15. The method of claim 1 further comprising directly measuring an ambient noise spectrum at the ear after it has been attenuated by the audiometer earphones and/or its enclosure.

16. The method of claim 1 further comprising measuring interaural attenuation in real time.

17. An audiometer for performing an acoustic test, said audiometer comprising:
a test sound field wherein the acoustic test is performed;
a speaker for introducing a test signal into the test sound field;
a microphone positioned in the test sound field for detecting sounds during an acoustic test and producing an output; and
a signal analyzer and controller for receiving and analyzing the output of the microphone, for producing control signals based on the analysis of the microphone output, and for controlling or modifying the acoustic test based on the control signals.

18. The audiometer of claim 17 further comprising an ambient noise monitoring system wherein the ambient noise monitoring system monitors the output of the microphone when the speaker is not producing a test signal and interrupts the test if the ambient noise exceeds a predetermined level.

19. The audiometer of claim 17 further comprising a memory for storing a set of acceptable test parameters wherein the test parameters are compared to the microphone output to determine if acceptable testing conditions exist.

20. The audiometer of claim 17 wherein the test field is defined by a pair of earphones and the internal dimensions of a test subject's ear.

21. The audiometer of claim 17 wherein the test field further comprises a free-field.

22. The audiometer of claim 17 further comprising an output port for downloading results of a test to a central computer for storage and processing.

23. The audiometer of claim 17 further comprising subject monitoring means for detecting noise produced by a test subject and repeating a test procedure if the noise exceeds a predetermined level during a test interval.

24. The audiometer of claim 17 wherein the signal analyzer and controller alters the test signals based upon the analysis of the microphone output.

25. An audiometer for performing an acoustic test, said audiometer comprising:
a speaker for producing an acoustic test signal in a test field;
a microphone for detecting sounds in the test field and producing an output signal based upon the detected sounds; and
a calibration system for adjusting the output of the speaker based upon the output of the microphone.
